(19) United States
(12) Patent Application Publication
(10) Pub. No.: US 2025/0149977 A1
(43) Pub. Date: May 8, 2025

(54) INVERTER SOFT STARTER

(71) Applicant: NIVALIS ENERGY SYSTEMS LLC, HUNT VALLEY, MD (US)

(72) Inventors: Justin LESNIAK, Milford, MI (US); Ryan KEMMET, Phoenix, AZ (US); Samuel PLUNKETT, Chicago, IL (US)

(73) Assignee: NIVALIS ENERGY SYSTEMS LLC, HUNT VALLEY, MD (US)

(21) Appl. No.: 18/779,633

(22) Filed: Jul. 22, 2024

Related U.S. Application Data
(60) Provisional application No. 63/596,440, filed on Nov. 6, 2023.

(51) Int. Cl. H02M 1/36; B60H 1/32; H02M 1/00

(52) U.S. Cl. CPC H02M 1/36; B60H 1/3226; H02M 1/0009

(57) ABSTRACT

A soft start inverter coupled to one or more batteries and configured to provide one or more output AC voltages for powering a compressor of a transport refrigeration unit (TRU). The soft start inverter is initialized in a low voltage/frequency mode to provide a first voltage at a first frequency. Upon determining that a relay within the compressor contactor is in a closed state and the compressor is commanded on, a controller may be configured to cause the soft start inverter to initiate a high voltage/frequency mode in which the soft start inverter provides a second voltage at a second frequency. Upon determining that the relay is in an open state and the current output by the soft start inverter has fallen below a predetermined threshold, the controller may be configured to cause the soft start inverter to return to the low voltage/frequency mode.

### CROSS REFERENCE TO RELATED APPLICATION

This application claims the benefit of U.S. Provisional Application, Ser. No. 63/596,440, filed on 6 Nov. 2023. The co-pending provisional application is hereby incorporated by reference herein in its entirety and is made a part hereof, including but not limited to those portions which specifically appear hereinafter.

### TECHNICAL FIELD

The present disclosure relates generally to the field of transport refrigeration systems and methods of operating the same, and more particularly to providing continuous and peak power balancing/softening/shaving for operation of electrical accessories in an electrical system associated with at least one of a vehicle, trailer, and transport refrigeration unit (“TRU”) system that is at least partially electrically powered.

### BACKGROUND

Refrigeration trucks and trailers provide an effective means of long-distance transport for perishable goods. Power requirements for maintaining the perishable load may encompass one or more of a compressor for circulating refrigerant, a fan for circulation of temperature-controlled air, a condenser, an evaporator, and an expansion valve. A transport refrigeration unit (“TRU”) system may be attached to the front of a trailer for maintaining controlled temperatures during transport. Typically, a TRU may be powered by a small diesel engine that is integral with the refrigeration system on the trailer. Many trailers are fitted with hybrid TRUs that allow for a switch between diesel and electric modes. In diesel mode, the small diesel engine may power an AC motor, which in turn powers a compressor, or it may be directly coupled to the compressor (i.e., mechanically connected). In electric mode, the AC motor may be powered by an electric source, such as one or more batteries and/or a utility source (i.e., “shore power”). More recently, fully electric TRUs have become more common.

Typically, electric motors have very high currents when they are first started. This is referred to as the “inrush” current. In some examples, the inrush current may be 10 to 20 times the normal operating current of the motor. The current supply for the electric motor is required to supply the inrush current in order to start the motor. This causes the supply to be sized for the inrush current instead of the normal operating current.

In stationary applications, such as buildings, this may not be a problem, as any single electric motor used in these applications require a much smaller total current than the supplied current. In other words, any total current used for electric motors in stationary applications tends to be a small fraction of the total building load. However, in mobile applications or even in stationary applications being powered by a generator, this can become a problem as the total load for the application may not be enough to provide total current. To deal with this, generators are typically sized to the maximum inrush currents as opposed to the operating current.

For example, in TRUs powered by diesel engine generators, the generator needs to be sized to power the inrush current as opposed to standard operating current. When running a compressor of a hybrid TRU on shore power, the shore power requires being able to supply the current for the inrush current. In a system with one or more batteries providing the electricity to, at least, the TRU instead of the shore power or engine, an inverter coupled to the TRU would need to be sized to supply the inrush current. This would dramatically increase the size of the inverter and increase the maximum battery output power, adding to the cost and weight of a system.

In many applications with high inrush current a soft softer may be utilized. A soft starter typically lowers the inrush current by lowering the voltage supplied to the motor and then ramping the voltage up to the nominal operating voltage. Soft starters generally do not have a power output until the motor load is activated. The soft starter also generally sits between the AC input and the motor to control the inrush current to the motor or other load.

A soft starter may temporarily reduce the load and torque in the powertrain and electric current surge of the motor during start-up. This may reduce the mechanical stress on the motor and shaft, as well as the electrodynamic stresses on the attached power cables and electrical power supply. Soft starters may be mechanical or electrical devices, or a combination of both. Mechanical soft starters may include clutches and several types of couplings using a fluid, magnetic forces, or steel shot to transmit torque, similar to other forms of torque limiter. Electrical soft starters may be any control system that reduces the torque by temporarily reducing the voltage or current input, or a device that temporarily alters how the motor is connected in the electric circuit.

A soft starter continuously controls the motor's voltage supply during the start-up phase. This way, the motor is adjusted to the machine's load behavior. Electrical soft starters can use solid state devices to control the current flow and therefore the voltage applied to the motor. They can be connected in series with the line voltage applied to the motor, or can be connected inside the delta (4) loop of a delta-connected motor, controlling the voltage applied to each winding. Solid state soft starters can control one or more phases of the voltage applied to the induction motor with the best results achieved by three-phase control. Soft starters controlled via two phases have the disadvantage that the uncontrolled phase will always shows some current unbalance with respect to the controlled phases.

Soft starters are an additional component that would need to be incorporated into a TRU or are mounted separately onto the vehicle or trailer. Soft starters add cost, weight, and complexity to the vehicle, trailer, and TRU system. The added cost, weight, and complexity are detrimental, particularly to mobile applications where weight savings and efficiency are important. Further, a TRU system that relies on a soft starter when connected to shore power may not function when connected to a generator without changing operating characteristics. Accordingly, there is a need to eliminate a separate soft starter while retaining the ability to lower the inrush current to the TRU and without increasing the size of existing components.

### SUMMARY OF THE INVENTION

The invention provides methods and systems for powering a transport refrigeration unit (“TRU”). The invention uses an inverter adapted to provide a ‘soft start’ function. This soft start inverter is coupled to one or more batteries and may be configured to convert the DC battery voltage to one or more output AC voltages for powering one or more electric loads of the TRU. The one or more electric loads of the TRU may include a compressor. As used herein, the term “compressor” may refer to one or more of an AC motor, a compressor, a single unit comprising an AC motor and compressor, a fan, a condenser, an evaporator, and an expansion valve. The soft start inverter may be initialized in a low voltage/frequency mode in which the one or more output AC voltages may be a first voltage at a first frequency. The soft start inverter may provide the one or more output AC voltages to an AC contactor of the TRU. The power delivered to the AC contactor may then be allocated (e.g., by a controller) to power the one or more electric loads of the TRU.

The invention further includes a method for powering a transport refrigeration unit (TRU). The method includes steps of: converting (e.g., with an inverter) a DC battery voltage to a first AC output having a first voltage at a first frequency; determining that a relay within a compressor contactor is in a closed state and a compressor of the TRU is commanded on; converting the DC battery voltage to a second AC output having a second voltage at a second frequency that is greater than the first AC output to power the compressor; determining that the relay within the compressor contactor is in an open state and a current draw has fallen below a predetermined threshold; and returning to the first AC output.

A controller may be coupled to the soft start inverter. The controller may be configured to monitor a state of a relay within a compressor contactor in the TRU and a current output by the soft start inverter. Upon determining that the relay within the compressor contactor is in a closed state and the compressor is commanded on, the controller may be configured to cause the soft start inverter to initiate a high voltage/frequency mode in which the one or more output AC voltages may be a second voltage at a second frequency. Upon determining that the relay within the compressor contactor is in an open state and the current output by the soft start inverter has fallen below a predetermined threshold, the controller may be configured to cause the soft start inverter to return to the low voltage/frequency mode.

The first voltage at the first frequency may be sufficient to power the one or more electric loads in the TRU other than the compressor. In an example, the first voltage may be approximately 350 VAC and the first frequency may be approximately 50 Hz. The first voltage at the first frequency can power fans, battery chargers (such as for the controller), resistive wire heaters, and/or the controller within the TRU. In embodiments, the first voltage at the first frequency is the only power connection for the TRU and powers all components in the TRU through the first and second voltages.

The second voltage at the second frequency may be sufficient for the compressor to operate at its full performance and highest efficiency. In an example, the second voltage may be approximately 480 VAC and the second frequency may be approximately 60 Hz. In another example, the second voltage may be approximately 400 VAC and the second frequency may be approximately 50 Hz. The predetermined threshold may be approximately 4 amps.

The initiating the high voltage/frequency mode may include ramping up the first voltage at the first frequency to the second voltage at the second frequency and may provide an inrush current for the compressor. The returning to the low voltage/frequency mode may include ramping down the second voltage at the second frequency to the first voltage at the first frequency.

### BRIEF DESCRIPTION OF DRAWINGS

Other objects and advantages of the present disclosure will become apparent to those skilled in the art upon reading the following detailed description of exemplary embodiments and appended claims, in conjunction with the accompanying drawings, in which like reference numerals have been used to designate like elements.

FIG. 1 is a diagram illustrating an exemplary transport refrigeration unit (“TRU”) and power supply system, according to an embodiment of the present disclosure.

FIG. 2 is an overall system diagram of a first example power supply system with a soft start inverter coupled to a controller is shown, according to an embodiment of the present disclosure.

FIG. 3 is an overall system diagram of a second example power supply system 42 with a first inverter 204 and a second inverter 304 coupled to the controller 206, according to an embodiment of the present disclosure.

FIG. 4 is a functional representation of the operation of the soft start inverter, according to an embodiment of the present disclosure.

FIG. 5 is a graphical representation of the output of the soft start inverter, according to an embodiment of the present disclosure.

The figures are for purposes of illustrating example embodiments, but it is understood that the inventions are not limited to the arrangements and instrumentality shown in the drawings. In the figures, identical reference numbers identify at least generally similar elements.

### DETAILED DESCRIPTION

The present disclosure describes systems, methods, and apparatuses configured to provide continuous and peak power balancing/softening/shaving for operation of electrical accessories in an electrical system associated with at least one of a vehicle, trailer, and transport refrigeration unit (“TRU”) that is at least partially electrically powered.

Embodiments of this invention include an inverter designed to reduce the inrush current of a TRU compressor motor during initial startup. This “soft start” inverter of this invention may slowly ramp up the power supplied to the compressor motor, reducing stress on both the motor itself and other connected components. The slow but steady acceleration of the motor also helps extend its life by avoiding the sudden jerking motion during rapid acceleration. In an example, with one or more batteries onboard a trailer supplying power to a TRU, the soft start inverter may be used as a variable frequency soft starter and a device to invert the DC battery power into 3 phase pure sine wave AC power.

The present disclosure will now be described more fully hereinafter with reference to the accompanying drawings, which form a part hereof, and which show, by way of non-limiting illustration, certain examples. Subject matter may, however, be described in a variety of different forms and, therefore, covered or claimed subject matter is intended to be construed as not being limited to any examples set forth herein. Among other things, subject matter may be described as methods, devices, components, or systems. Accordingly, examples may take the form of hardware, software, firmware or any combination thereof (other than software per se). The following detailed description is, therefore, not intended to be taken in a limiting sense.

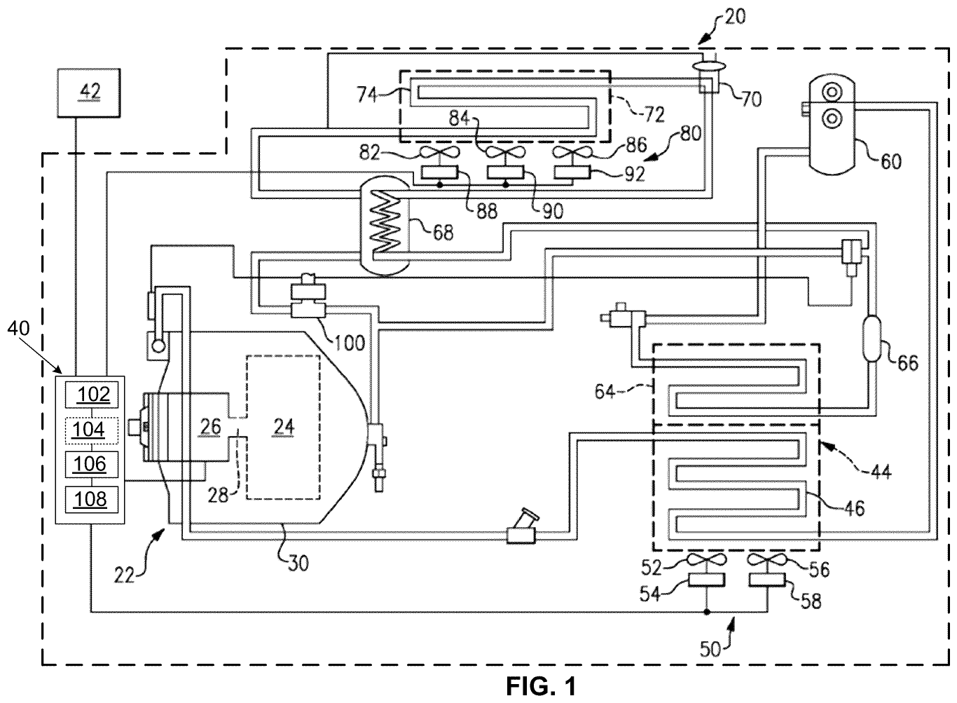

Referring now to FIG. 1, a diagram illustrating an exemplary TRU 20 and one or more power supply systems 42 is shown. The TRU 20 shown in FIG. 1 is meant for illustrative purposes and is not intended to limit the present disclosure. Different configurations and components may be used for the TRU 20 and still fall within the scope of the present disclosure.

The TRU 20 may include a compressor system 22. The compressor system 22 may include a compressor 26, a compression chamber 24, and a compression mechanism. Optionally, the compressor system 22 may be sealed within a common housing 30. As used herein, the compressor 26 may include one or more of an AC motor, a compressor, a single unit comprising an AC motor and compressor, a fan, a condenser, an evaporator, and an expansion valve.

A power delivery system 40 may be connected to and/or incorporated within the TRU 20 and may be capable of driving the compressor 22 in one or more ways, as described below. The power delivery system 40 may also provide power to satisfy electrical requirements of other portions of the TRU 20. In an example, the power delivery system 40 may integrate one or more power supply systems 42 into the TRU 20 via, for example, an AC contactor 106 and may deliver power to the compressor via a compressor contactor 108. The power delivery system 40 may include a controller that may be used to control power usage in the TRU 20.

Refrigerant may enter the compressor 26 and may be compressed to a higher temperature and pressure. Refrigerant gas may then move into an air-cooled condenser 44. Air flowing across a group of condenser coil fins and tubes 46 may cool the gas to its saturation temperature. The air flow across the condenser 44 may be energized by a condenser fan assembly 50 having one or more fans. The illustrated example includes a fan 52, an electrical condenser fan motor 54, and a second fan 56 having an electrical motor 58. The controller within the power delivery system 40 may regulate power supply to one or more of the electrical condenser fan motor 54 and the electrical motor 58.

By removing latent heat, the gas may condense to a high pressure/high temperature liquid and flow to a receiver 60 that may provide storage for excess liquid refrigerant during low temperature operation. From the receiver 60, the liquid refrigerant may pass through a subcooler heat exchanger 64, through a filter dryer 66 that may keep the refrigerant cool and dry, then to a heat exchanger 68 that may increase the refrigerant subcooling, and then pass to a thermostatic expansion valve 70.

As the liquid refrigerant passes through the expansion valve 70, some of it may vaporize into a gas. Return air from the refrigerated space may flow over the heat transfer surface of an evaporator 72. As refrigerant flows through tubes 74 in the evaporator 72, the remaining liquid refrigerant may absorb heat from the return air, and in so doing, may be vaporized. The air flow across the evaporator may be energized by an evaporator fan assembly 80. The illustrated example includes a first fan 82, a second fan 84, and a third fan 86 that may be respectively powered by a first electric fan motor 88, a second electric fan motor 90, and a third electric fan motor 92. The first electric fan motor 88, the second electric fan motor 90, and the third electric fan motor 92 may receive their electrical power from at least one of the one or more power supply systems 42 and/or the power delivery system 40. The controller within the power control system 42 may control the consumption of power and operations of the first electric fan motor 88, the second electric fan motor 90, and the third electric fan motor 92 of the evaporator fan assembly.

Refrigerant vapor may flow through a suction modulation valve 100 back to the compressor system 22 and the compressor 26. A thermostatic expansion valve bulb or sensor may be located on the evaporator outlet tube. The bulb may control the thermostatic expansion valve 70, to control refrigerant super-heating at the evaporator outlet tubing.

In an example, the power delivery system 40 may include only an electric motor 102 directly mechanically coupled to the compressor 26. In another example, the power delivery system 40 may include a dedicated engine and internal generator (e.g., an internal combustion engine (“ICE”) system) 104 the electric motor 102. The ICE system 104 and/or the electric motor 102 may be directly mechanically coupled to the compressor 26. While the horsepower of the ICE system 104 may vary, in one example it is contemplated that the ICE system may have approximately 20 to approximately 25 horsepower, although higher horsepower ICE systems are contemplated. The electric motor 102 may be generally operable over a wide range of voltages (e.g., between 400 VAC 3 phase 50 Hz and).

If the power delivery system 40 includes the ICE system 104, it may also include an internal generator that is driven by the dedicated engine to produce an amount of power for the specific application. In an example, the internal generator may be a 120 volt AC generator capable of a power output of approximately 3 kW to approximately 3.5 kW. In another example, the internal generator may be an AC generator capable of producing approximately 327 VAC to approximately 537 VAC at up to 29 A (approximately 9.4 kW to approximately 15.6 kW). The internal generator may be coupled to the electric motor 102 and may be used to power one of more of the electric motor 102 and other electronics within the TRU 20 and on the vehicle itself.

Additionally, or alternatively, the electric motor 102 may be coupled to the one or more power supply systems 42. The one or more power supply systems 42 may include one or more of a main generator powered by the main engine of a vehicle connected to the trailer, one or more batteries, and shore power. The power delivery system 40 may be capable of switching (either manually or automatically) between one or more of the internal generator of the ICE system 104 and the one or more power supply systems 42, For example, the electric motor 102 may be powered by one of the one or more of the batteries, the internal generator of the ICE system 104, and the main generator while the trailer is moving and one of the one or more batteries, the internal generator of the ICE system 104, and the shore power when the trailer is stationary and plugged into an electrical connection. In an example, the electric motor 102 may completely bypass the ICE system 104 altogether, allowing the ICE system 104 to remain unused or be completely removed from the TRU 20 altogether.

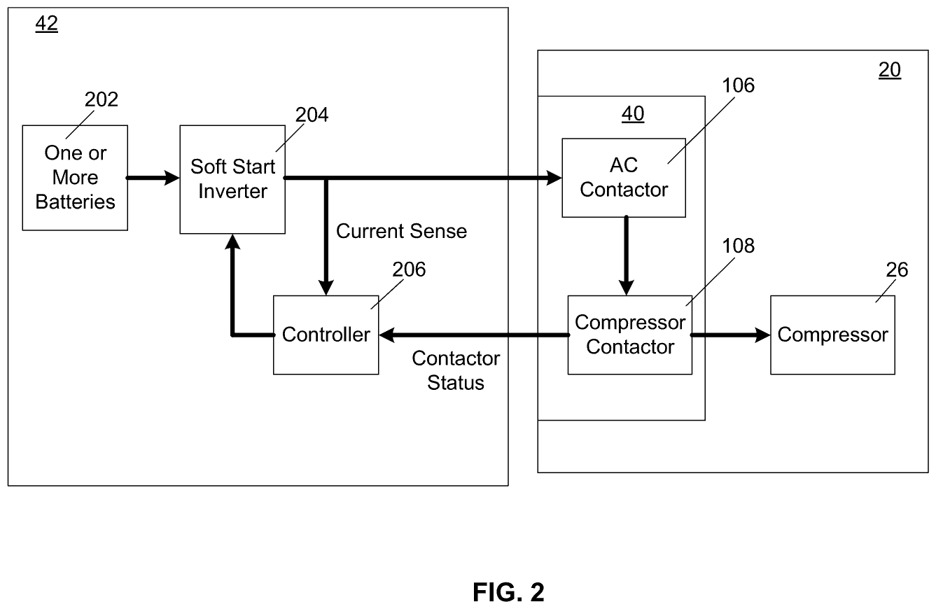

Referring now to FIG. 2, an overall system diagram of a first example power supply system 42 with a soft start inverter 204 coupled to a controller 206 is shown. One or more batteries 202 may provide DC power to the soft start inverter 204. The soft start inverter 204 converts the DC power to AC power and outputs the AC power to the AC contactor 106 within the power supply system 42 of the TRU 20. The power delivered to the AC contactor 106 may be allocated (e.g., by a controller) to power one or more electric loads of the TRU 20.

In an example, the TRU 20 may be a conventional off the shelf TRU requiring no modifications. The controller 206 may include one or more processors operatively coupled to a memory (i.e., a non-transitory storage medium) storing instructions that cause the one or more processors and therefore the controller 206 to adjust the operation of the soft start inverter 204 based on a monitoring of one or more inputs. The soft start inverter 204 may be initialized by the controller 206 in a low voltage/frequency mode in which it outputs a first voltage at a first frequency. The first voltage at the first frequency may be sufficient to power other components of the system, including those within the TRU 22. In an example, the first voltage may be 300-400 VAC, desirably approximately 350 VAC, and the first frequency may be approximately 40-60 Hz, desirably 45 or 50 Hz.

When a relay within the compressor contactor 108 is closed in order to start the compressor 26, the controller 206 may cause the soft start inverter 204 to initiate a high voltage/frequency mode in which it outputs a second voltage at a second frequency. The second voltage at the second frequency may be sufficient for the compressor 26 to additionally operate at its full performance and highest efficiency. In an example, the second voltage may be 400-500 VAC, desirably approximately 480 VAC, and the second frequency may be 50-65 Hz, desirably approximately 60 Hz. In another example, the second voltage may be approximately 400 VAC and the second frequency may be approximately 50 Hz. The controller 206 may detect when the relay is closed by receiving a contactor status from the compressor contactor 108. The controller 206 may cause the soft start inverter 204 to initiate the high voltage/frequency mode.

The soft start inverter 204 may remain in the high voltage/frequency mode until the relay within the compressor contactor 108 is opened and current output by the soft start inverter 204 drops below a predetermined value. In an example, the predetermined value may be approximately 4 amps. The controller 206 may measure the current output from the soft start inverter 204. Once the relay within the compressor contactor 108 is open and the current drops below the predetermined value, the controller 206 may cause the soft start inverter 204 to return to the low voltage/frequency mode. The soft start inverter 204 may remain in the low voltage/frequency mode until the relay within the compressor contactor 108 is closed again.

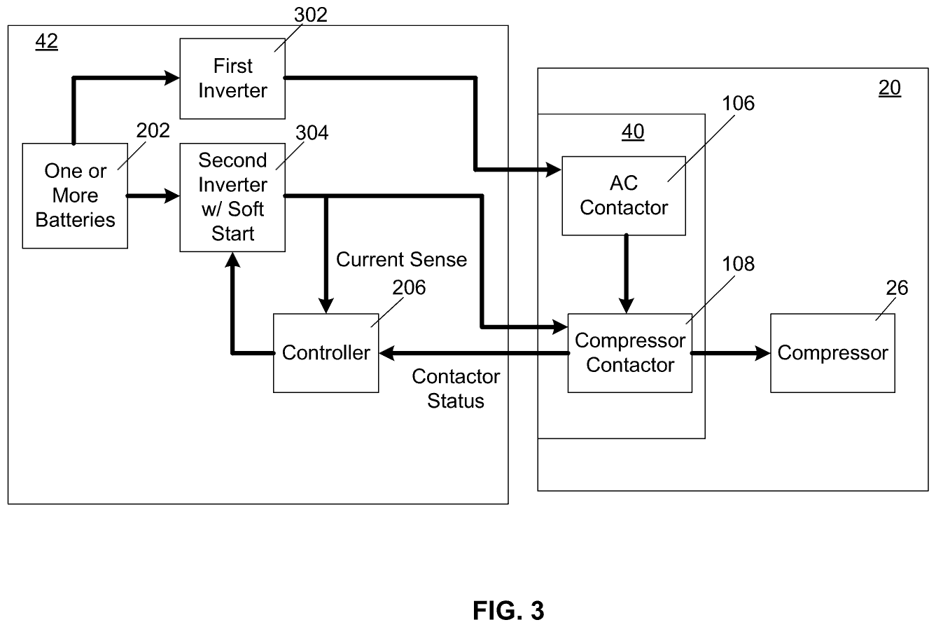

Referring now to FIG. 3, an overall system diagram of a second example power supply system 42 with a first inverter 204 and a second inverter 304 coupled to the controller 206 is shown. The second example power supply system 42 may include a first inverter 302 and a second inverter 304. The first inverter 302 may be dedicated to outputting AC power to components in the TRU 20 other than the compressor 26. The second inverter 204 may include a soft start function and may be dedicated to providing AC power to the compressor 26.

The one or more batteries 202 may provide DC power to the first inverter 302 and the second inverter 304. The first inverter 302 may convert the DC power to AC power and output the AC power to the AC contactor 106 within the power supply system 42 of the TRU 20 to power the components in the TRU 20 other than the compressor 26. The first inverter 302 may provide a continuous 400 VAC or 480 VAC 3 phase power to the one or more electric loads of the TRU other than the compressor 26. In an example, the first inverter 302 may output approximately 480 VAC at approximately 60 Hz. In another example, the first inverter 302 may output approximately 400 VAC at approximately 50 Hz. The power delivered to the AC contactor 106 may be allocated (e.g., by a controller) to power one or more electric loads of the TRU 20.

The second inverter 304 may convert the DC power to AC power and output the AC power to the compressor contactor 108 within the power supply system 42 of the TRU 20.

The controller 206 may include one or more processors operatively coupled to a memory (i.e., a non-transitory storage medium) storing instructions that cause the one or more processors and therefore the controller 206 to adjust the operation of the second inverter 304 based on a monitoring of one or more inputs. The second inverter 304 may remain off until the compressor is commanded on. Alternatively, the second invertor 304 may be initialized by the controller 206 in a low voltage/frequency mode in which it outputs a first voltage at a first frequency. In an example, the first voltage at the first frequency may be sufficient to power other components of the system, including those within the TRU 22. In another example, the first voltage may be a low voltage (e.g., near 0 V) and the first frequency may a be a low frequency (e.g., near 0 Hz).

When the relay within the compressor contactor 108 is closed in order to start the compressor 26, the controller 206 may cause the second inverter 304 to initiate a high voltage/frequency mode in which it outputs a second voltage at a second frequency. The second voltage at the second frequency may be sufficient for the compressor 26 to operate at its full performance and highest efficiency. In an example, the second voltage may be approximately 480 VAC and the second frequency may be approximately 60 Hz. In another example, the second voltage may be approximately 400 VAC and the second frequency may be approximately 50 Hz. The controller 206 may detect when the relay is closed by receiving a contactor status from the compressor contactor 108. The controller 206 may cause the second inverter 304 to initiate the high voltage/frequency mode.

The second inverter 304 may remain in the high voltage/frequency mode until the relay within the compressor contactor 108 is opened and current output by the second inverter 304 drops below a predetermined value. In an example, the predetermined value may be approximately 4 amps. The controller 206 may measure the current output from the second inverter 304. Once the relay within the compressor contactor 108 is open and the current drops below the predetermined value, the controller 206 may cause the second inverter 304 to return to either the off mode or the low voltage/frequency mode. The second inverter 304 may remain off or in the low voltage/frequency mode until the relay within the compressor contactor 108 is closed again.

The first inverter 302 and the second inverter 304 may provide power in the same phase. The TRU 20 may be configured to check the phase of the first inverter 302 to determine which way the compressor 26 will turn. If the phases are not fixed between the first inverter 302 and the second inverter 304, the compressor 26 may attempt to spin backwards or not spin at all. The second inverter 304 may provide power through a traditional soft starter. In this example, the compressor 26 motor would have a soft starter inline and the soft starter would add resistance and then reduce that resistance to zero over a period of time. On the output side of the soft starter, the voltage may be significantly reduced, but the second inverter 304 may still produce 400 VAC or 480 VAC 3 phase power. Alternatively, an inverter that ramps up starting from zero volts could be used for the compressor 26 motor and may provide the power in an allowable period of time.

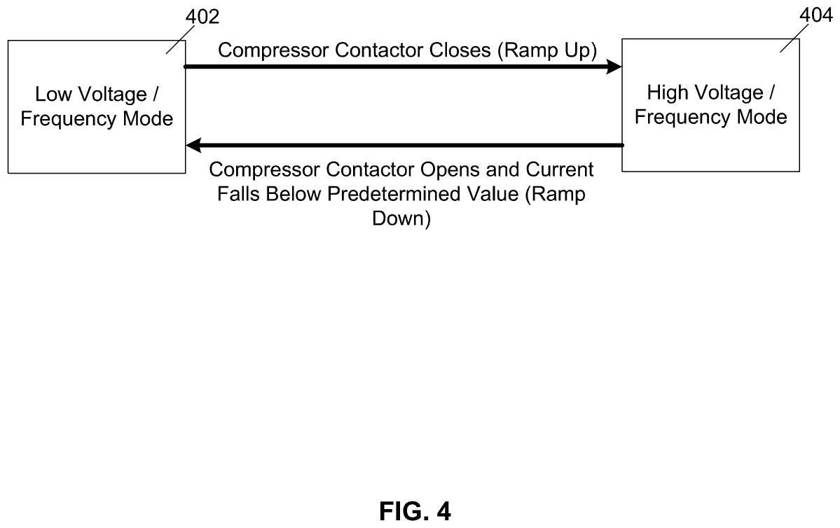

Referring now to FIG. 4, a functional representation of the operation of the soft start inverter 204 is shown. The soft start inverter 204 may be initialized by the controller 206 in the low voltage/frequency mode 404 in which it outputs the first voltage at the first frequency. When the relay within the compressor contactor 108 closes, the controller 206 causes the soft start inverter 204 to ramp up its output to the high voltage/frequency mode 404 in which it outputs the second voltage at the second frequency. When the relay within the compressor contactor 108 is open and the current drops below the calibrated value, the controller 206 may cause the soft start inverter 204 to return to the low voltage/frequency mode 402.

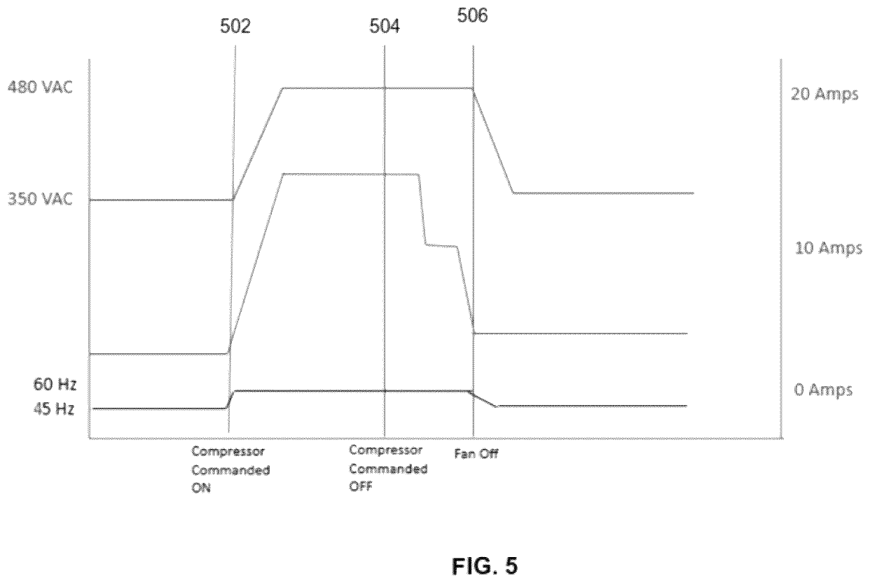

Referring now to FIG. 5, a graphical representation of an example output of the soft start inverter 204 is shown. As described above, the soft start inverter 204 may initialize in the low voltage/frequency mode. At step 502, the relay within the compressor contactor 108 may be closed in order to start the compressor 26 and the controller 206 may cause the soft start inverter 204 to initiate the high voltage/frequency mode. At this point, the output of the soft start inventor 204 may be ramped up from approximately 350 VAC at 45 or 50 Hz to approximately 480 VAC at 60 Hz. In an example, the ramp up may be approximately 5 s to approximately 20 s, although different ranges are contemplated.

At step 504, the compressor 26 may be commanded to stop and the relay within the relay within the compressor contactor 108 may be opened. The soft start inventor 204 may continue to operate in the high voltage/frequency mode, but the current output may begin decreases as the compressor 26 begins to wind down.

At step 506, the controller 26 may determine that the current output by the soft start inverter 204 has dropped below the predetermined value. This may coincide with the fan of the compressor 26 stopping (i.e., the second drop in amperage curve). The controller 206 may cause the soft start inverter 204 to return to the low voltage/frequency mode. At this point, the output of the soft start inventor 204 may be ramped down from approximately 480 VAC at 60 Hz to approximately 350 VAC at 45 or 50 Hz. In an example, the ramp down may be approximately 5 s to approximately 20 s, although different ranges are contemplated.

By initializing in the low frequency/voltage mode and maintaining this mode while the compressor is not on, the soft start inverter 204 is able to supply power for the inrush current and then ramp to the most efficient operation. This operation of the soft start inverter 204 may increase run time and improve overall efficiency by providing the low voltage/frequency output to run other components of the TRU 20 and other systems when the compressor 20 is not running. Operating in the low voltage/frequency mode may prevent the soft start inverter 204 from being overdrawn/overloaded when the compressor 26 starts. Due to the physical characteristics of systems such as these, the ability to sense/respond to the compressor 26 turning on or off will suffer from some delay. However, the configuration of the soft start inverter 204 and controller 206 may minizine any faults within the TRU 20, even if timing is not perfectly matched (i.e., being a little late on the ramping).

By using the low voltage/frequency mode as the default mode for the soft start inverter 204 and utilizing the ramp up from the low voltage/frequency mode to the high voltage/frequency mode when the relay within the compressor contactor 108 is closed allows the soft start inverter 204 to be sized for the typical operating load of the TRU 20 and other systems, which may be significantly lower than the inrush current. This may reduce costs and weight. Further, if the default mode for the soft start inverter 204 was the high voltage/frequency mode, there may not be enough time for the controller 206 to send a signal to the soft start inverter 204 to properly ramp down once it senses that the relay within the compressor contact 108 is closed. In this scenario, the soft start inverter 204 may not be able to ramp down fast enough to provide the correct inrush current for the compressor 26.

The methods described herein, including those with reference to one or more flowcharts, may be performed by a controller and/or processing device (e.g., smartphone, computer, etc.). The methods may include one or more operations, functions, or actions as illustrated in one or more of blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation. Dashed lines may represent optional and/or alternative steps.

Additional examples of the presently described method and device embodiments are suggested according to the structures and techniques described herein. Other non-limiting examples may be configured to operate separately or may be combined in any permutation or combination with any one or more of the other examples provided above or throughout the present disclosure. Components and/or arrangement of components illustrated in one figure may be incorporated into any other figure.

It will be appreciated by those skilled in the art that the present disclosure may be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The terms “including” and “comprising” should be interpreted as meaning “including, but not limited to.” If not already set forth explicitly in the claims, the term “a” should be interpreted as “at least one” and the terms “the, said, etc.” should be interpreted as “the at least one, said at least one, etc.”

The present disclosure is described with reference to block diagrams and operational illustrations of methods and devices. It is understood that each block of the block diagrams or operational illustrations, and combinations of blocks in the block diagrams or operational illustrations, may be implemented by means of analog or digital hardware and computer program instructions. These computer program instructions may be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks may occur out of the order noted in the operational illustrations. For example, two blocks shown in succession may be executed substantially concurrently or the blocks may sometimes be executed in the reverse order, depending upon the functionality/acts involved.

For the purposes of this disclosure a non-transitory computer readable medium (or computer-readable storage medium/media) stores computer data, which data may include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which may be used to tangibly store the desired information or data or instructions and which may be accessed by a computer or processor.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

It is the Applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

What is claimed is:

1. A system for powering a transport refrigeration unit (TRU), the system comprising:
one or more batteries configured to supply a DC battery voltage;
a soft start inverter coupled to the one or more batteries and configured to convert the DC battery voltage to one or more output AC voltages for powering a compressor of the TRU, the soft start inverter initialized in a low voltage/frequency mode in which the one or more output AC voltages comprises a first voltage at a first frequency; and
a controller coupled to the soft start inverter, the controller configured to monitor a state of a relay within a compressor contactor in the TRU and a current output by the soft start inverter, wherein:
upon determining that the relay within the compressor contactor is in a closed state and the compressor is commanded on, the controller is configured to initiate a high voltage/frequency mode by the soft start inverter in which the one or more output AC voltages comprises a second voltage at a second frequency, and
upon determining that the relay within the compressor contactor is in an open state and the current output by the soft start inverter has fallen below a predetermined threshold, the controller is configured to return the soft start inverter to the low voltage/frequency mode.

2. The system of claim 1, wherein the first voltage at the first frequency powers components in the TRU other than the compressor.

3. The system of claim 2, wherein the first voltage at the first frequency powers a fan, a battery charger, and/or a resistive wire heater within the TRU.

4. The system of claim 2, wherein the high voltage/frequency mode powers the compressor and the components in the TRU other than the compressor.

5. The system of claim 1, wherein the first voltage at the first frequency powers the controller.

6. The system of claim 1, wherein the soft start inverter is the only power connection to the TRU.

7. The system of claim 1, wherein the first voltage is approximately 350 VAC and the first frequency is approximately 45 Hz.

8. The system of claim 1, wherein the second voltage at the second frequency is sufficient for the compressor to operate at its full performance and highest efficiency.

9. The system of claim 1, wherein the second voltage is approximately 480 VAC and the second frequency is approximately 60 Hz.

10. The system of claim 1, wherein the second voltage is approximately 400 VAC and the second frequency is approximately 50 Hz.

11. The system of claim 1, wherein the initiate the high voltage/frequency mode comprises ramping up the first voltage at the first frequency to the second voltage at the second frequency.

12. The system of claim 1, wherein the low voltage/frequency mode lowers an inrush current to the compressor and the initiate the high voltage/frequency mode occurs after at least a portion of the inrush current is overcome.

13. The system of claim 1, wherein the return to the low voltage/frequency mode comprises ramping down the second voltage at the second frequency to the first voltage at the first frequency.

14. The system of claim 1, wherein the predetermined threshold is approximately 4 amps.

15. The system of claim 1, wherein the soft start inverter provides the one or more output AC voltages to an AC contactor of the TRU.

16. The system of claim 1, wherein the compressor comprises one or more of an AC motor, a compressor, a single unit comprising an AC motor and compressor, a fan, a condenser, an evaporator, and an expansion valve.

17. A method for powering a transport refrigeration unit (TRU), the method comprising:
converting a DC battery voltage to a first AC output having a first voltage at a first frequency;
determining that a relay within a compressor contactor is in a closed state and a compressor of the TRU is commanded on;
converting the DC battery voltage to a second AC output having a second voltage at a second frequency that is greater than the first AC output to power the compressor;
determining that the relay within the compressor contactor is in an open state and a current draw has fallen below a predetermined threshold; and
returning to the first AC output.

18. The method of claim 17, wherein the converting steps are performed by an inverter.

19. The method of claim 17, wherein the first AC output powers components in the TRU other than the compressor.

20. The method of claim 17, further comprising ramping up the first voltage at the first frequency to the second voltage at the second frequency.
